(19) United States
(12) Patent Application Publication
(10) Pub. No.: US 2008/0276482 A1
(43) Pub. Date: Nov. 13, 2008

(54) Freeze Drying of Target Substances

(75) Inventors: John Morton Broughall, Oxfordshire (GB); Charles Richard Wedge, Oxfordshire (GB); Charles Monroe, Oxfordshire (GB)

Correspondence Address: FULWIDER PATTON LLP, HOWARD HUGHES CENTER, 6060 CENTER DRIVE, TENTH FLOOR, LOS ANGELES, CA, 90045, US

(73) Assignee: OXFORD BIOSENSORS LIMITED, Oxfordshire (GB)

(21) Appl. No.: 12/096,779

(22) PCT Filed: Dec. 8, 2006
(86) PCT No.: PCT/GB2006/004600

§ 371 Date: Jul. 29, 2008

(30) Foreign Application Priority Data
Dec. 9, 2005 (GB) 0525115.2

(51) Int. Cl. F26B 5/06

(52) U.S. Cl. 34/287; 34/92

(57) ABSTRACT

A target substance (8) is subject to a freeze drying process in which the substance is first passed into a freeze chamber (31) to reduce the temperature of the substance, and then passed into a separate vacuum chamber (32) in which a vacuum is applied to promote drying of the target substance. Because the carrier (10) and target substance (8) is moved from a freeze chamber (31) to a separate vacuum chamber (32) the environment can be more closely controlled and the cycling of freezing to drying can be more rapid. In this way the carrier (10) and target substance (8) is subject to the full temperature cycling without the surrounding chamber and apparatus being subject to the full cycle. This reduces time and energy costs. The technique is particularly suited to manufacturing biosensors using freeze dried reagents.

The present invention relates to freeze drying of a target substance and particularly, but not exclusively to a technique and apparatus suitable for freeze drying a reagent such as an electro-active substance, in situ in an electrochemical cell of a sample analyser device.

It is desirable to freeze dry target material in various applications and typically it is of benefit to minimise cycle times for the process without reducing the effectiveness of the freeze drying process. An improved technique and apparatus have been devised.

According to a first aspect, the present invention provides apparatus for freeze drying a target substance, the apparatus comprising:

At least one freeze chamber in which to reduce the temperature of the target substance; and,

at least one vacuum chamber adjacent the freeze chamber and to which the target substance is passed following exit from the freeze chamber, and in which a vacuum can be applied to promote drying of the target substance.

Typically the target substance will be carried on a carrier.

According to a further aspect, the invention provides a process for freeze drying a target substance the process comprising;

providing a target substance carried by a carrier;

passing the carrier and target substance into a separate freeze chamber to reduce the temperature of the target substance;

passing the carrier and target substance to a vacuum chamber, in which a vacuum is applied to promote drying of the target substance;

removing the carrier and target substance from the vacuum chamber.

Because the carrier and target substance is moved from a freeze chamber to a separate vacuum chamber the environment can be more closely controlled and the cycling of freezing to drying can be more rapid. In this way the carrier and target substance is subject to the full temperature cycling without the surrounding chamber and apparatus being subject to the full cycle. This reduces time and energy costs.

According to a further aspect, the invention provides a method of manufacturing a biosensor device.

The carrier may for example be a strip or sheet and the target material (which is typically initially introduced in liquid form) may be deposited in a well.

The freeze chamber processing ensures any liquid (e.g. water) and moisture present forms into solid particles. The vacuum/dryer processing ensures the crystals sublime to leave a dry residual target material in solid form.

The invention is particularly suited to small volume applications, preferably in which the target substance is deposited on or in a carrier, in liquid form (typically a well) in volumes of 1 nano litre to 1000 nano litres.

Preferred features of the invention are presented in the dependent claims and described in relation to the specific embodiments.

The invention will now be further described in specific embodiments, by way of example only, and with reference to the accompanying drawings, in which:

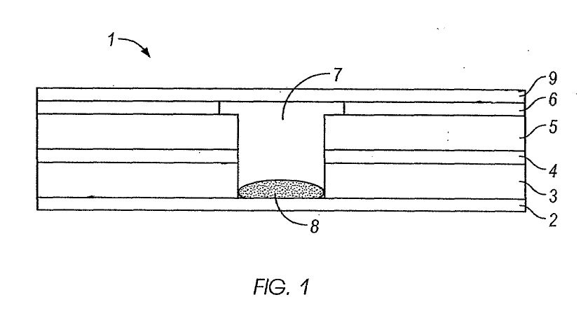

FIG. 1 is a schematic side view of an electrochemical cell;

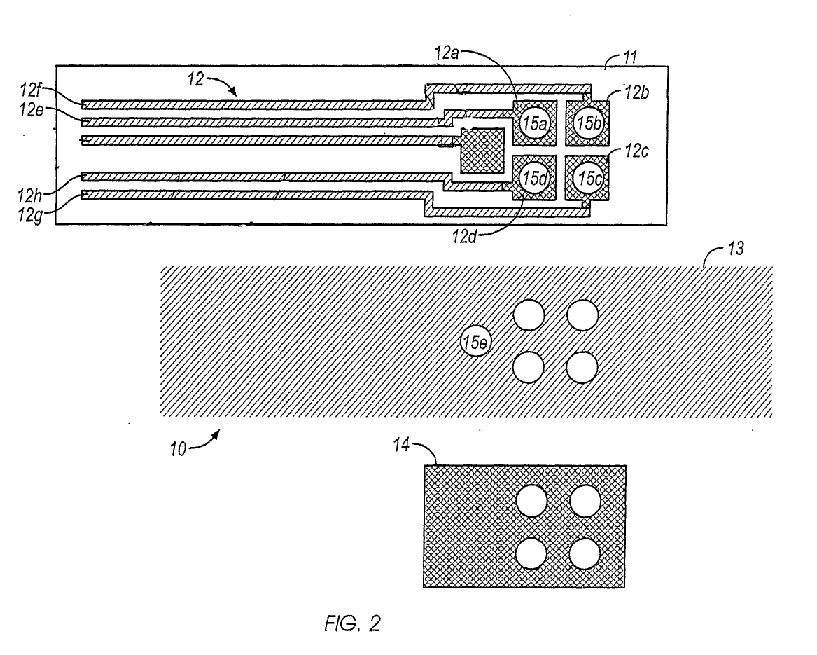

FIG. 2 is a schematic plan view of a sensor strip comprising four electrochemical cells.

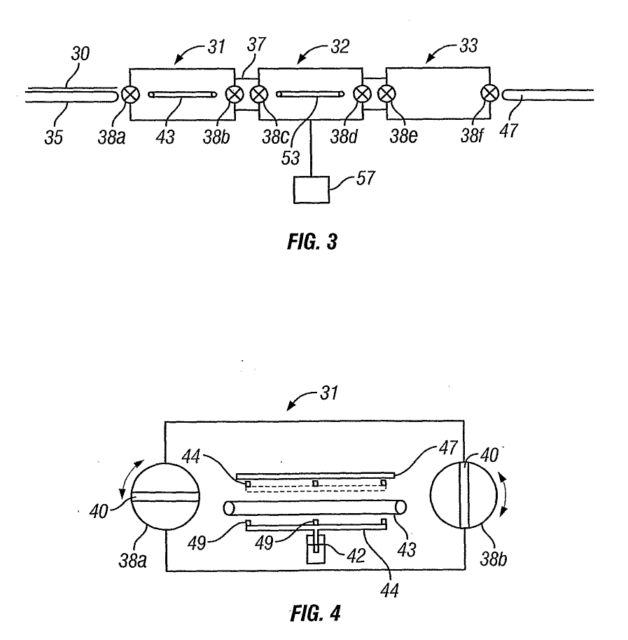

FIG. 3 is a schematic side view of exemplary apparatus in accordance with the invention for operating the process according to the invention;

FIG. 4 is a schematic side view of the freeze chamber of the apparatus of FIG. 3.

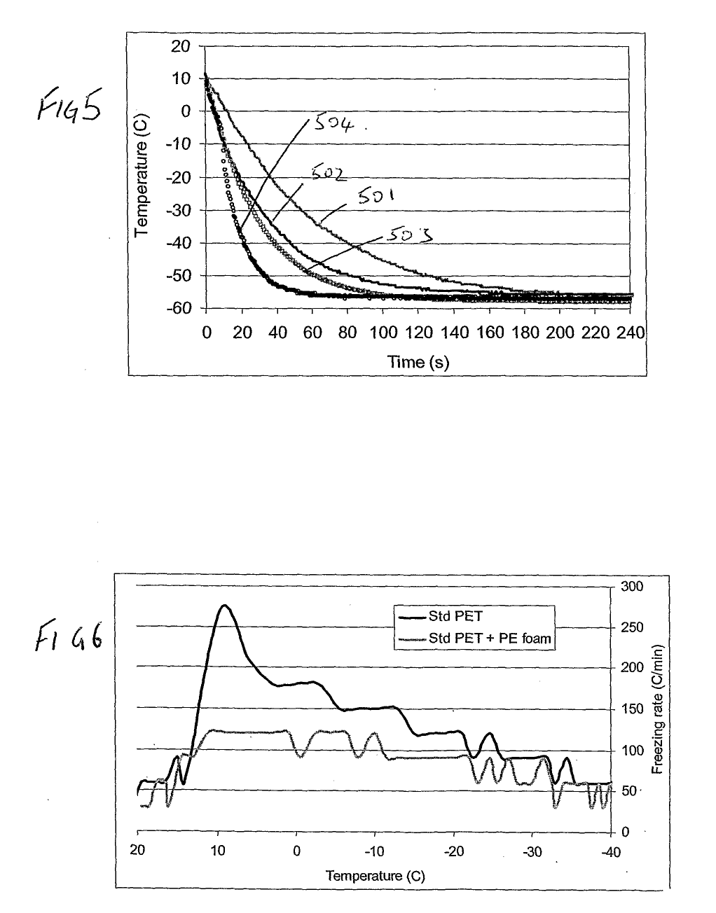

FIG. 5 is a graph showing the effect of temperature over time in the freeze chamber in different scenarios;

FIG. 6 is a graph showing change in freezing rate depending upon the presence or otherwise of an insulation layer;

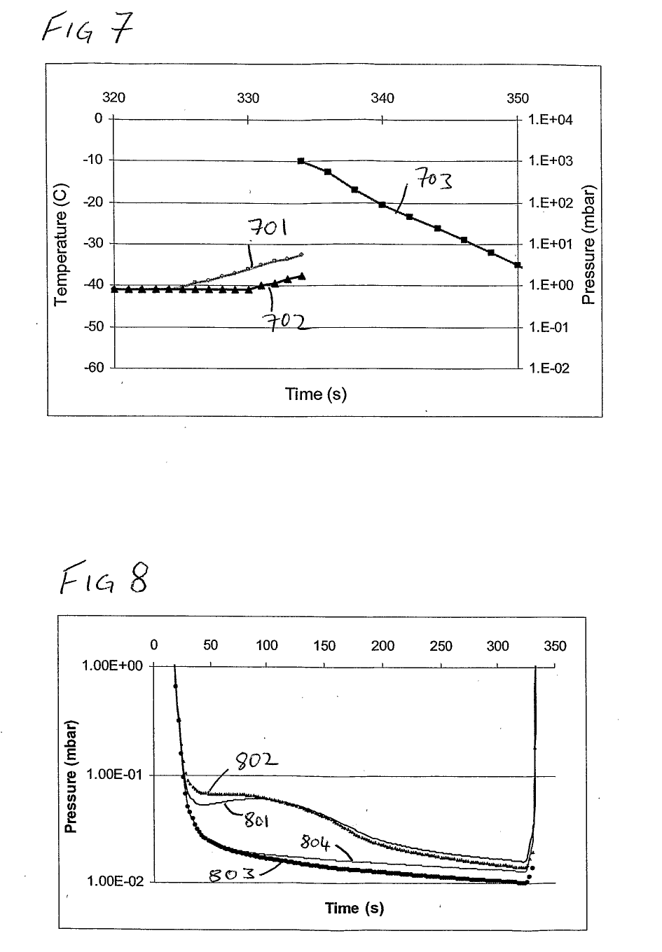

FIG. 7 is a graph showing temperature against time for the vacuum dryer chamber in differing scenarios;

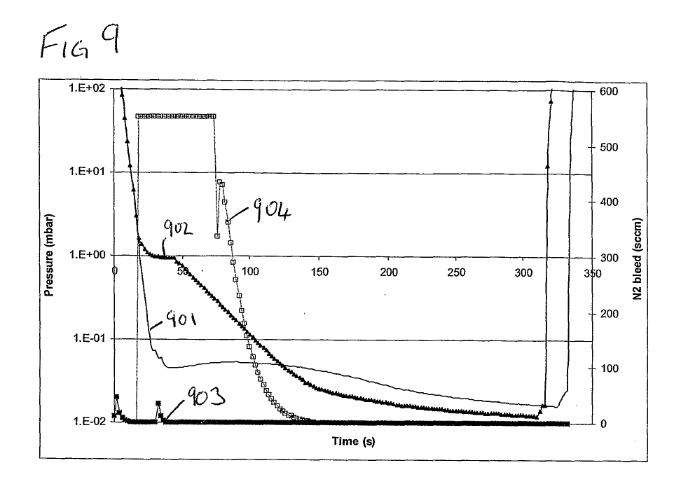

FIG. 8 is a graph showing pressure within the vacuum dryer chamber in differing scenarios;

FIG. 9 is a graph showing the effect of nitrogen bleed into the vacuum dryer chamber in differing scenarios.

Referring now to FIG. 1 of the accompanying drawings, an electrochemical cell 1, illustrated in a cross sectional side view, comprises a base layer 2 formed from a non-conducting porous material. The base layer 2 preferably has a thickness of 50-250 μm, preferably around 125 μm.

A non-conducting supporting layer 3 is formed on the base layer 2. The supporting layer 3 is preferably formed from PET and has a thickness in the range of 50 μm to 500 μm, preferably 250 μm, 150 μm or 50 μm.

The supporting layer 3 forms a support on which a working electrode 4 is formed. The working electrode 4 is preferably in the form of a continuous band around the wall(s) of the cell 1. The thickness of the working electrode 4, which is its dimension in a vertical direction when the cell 1 is placed on the base 2, is typically from 0.01 to 50 micro meters. Preferred and possible thicknesses of the working electrode are as described in our co-pending application WO 03/056319.

The working electrode 4 is preferably formed from carbon, for example in the form of conducting ink. A preferred carbon based conducting ink comprises a suspension of carbon dispersed in a resin solution. The working material may be formed of other materials and inks as detailed in WO 03/056319. Furthermore, two or more layers of the same or different materials may be used to form the working electrode.

A dielectric layer 5 comprising an insulating material typically a polymer, a plastic or ceramic again as detailed in WO 03/056319 is formed on and insulates the working electrode 4 from a pseudo-reference electrode 6. Typically, the dielectric layer 5 is of thickness 1 to 1000 μm. The dielectric layer could be formed of more than one layer.

The cell 1 is formed to have one or more wells 7.

Well diameters of 0.1 mm to 5 mm may be utilised dependent upon the particular application. Where non circular wells are used, the length or width dimension will typically be in the range 0.1 mm to 5 mm (more typically 0.9 to 1 mm). Typically the well depth will be in the range 50 μm to 1000 μm, preferably 50 μm to 500 μm, more preferably about 150 μm or 50 μm.

The base layer 2 forms the bottom of the well 7 and may take the form of a porous membrane.

The open end of the cell may be covered with a membrane 9 that is permeable to components of the sample to be tested, for example blood or plasma. The membrane may also be used to filter out components of the sample that should not enter the cell, for example red blood cells.

Referring now to FIG. 2 of the drawings, there is illustrated in a schematic plan view, layers of a sensor strip 10 comprising four electrochemical cells of the type and made as described above.

The sensor strip 10 comprises an insulating substrate sheet 11. Formed on the insulating substrate sheet 11 is a patterned layer 12 of material that forms four working electrodes 12a, 12b, 12c and 12d, one for each of the respective four cells and four conductive tracks 12e, 12f, 12g and 12h each of which in electrical contact with a respective one of the four working electrodes 12a, 12b, 12c and 12d.

It will be appreciated that for ease of viewing the various layers, the dielectric layer 13 and the pseudo-reference electrode layer 14 are each illustrated shifted laterally sideways from their true positions in the strip 10.

An electro-active substance 8 is contained within the well 7. The electro-active substance 8 is freeze dried in accordance with the invention to form a porous deposit. On introduction of a measurement sample (not shown) into the well 7 the electro-active substance 8 dissolves and an electrochemical reaction may occur and a measurable current, voltage or charge may occur in the cell. Electro-active substances are discussed in more detail in, for example our co-pending application WO 03/056319.

The sensor strips 10 are formed on a base sheet 30 which acts as a substrate for a large number of strips 10. The substrate base sheet 30 may comprise the PET base layer 3 of the respective cells when the strips 10 are eventually divided from the base sheet.

The electro-active substance is introduced in to the wells 7 of the strips supported on the base sheet 30 in liquid form (aqueous solution). The well is typically about 1 mm diameter and a measured dose (for example 0.4 micro litres) of liquid is introduced into each well 7. Liquid is then subjected to a freeze drying process in accordance with the present invention. The technique of the present invention is particularly suitable for freeze drying an array of wells containing micro volumes of liquid, typically in the range 1 nano litre to 1000 nano litres, more typically in the range of 200 nano litres to 700 nano litres, most typically in the range 200 nano litres to 400 nano litres.

The freeze drying apparatus of the present invention, as shown in FIG. 3, comprises a freezing chamber 31 and a vacuum/dryer chamber 32. A warm chamber 33 may be provided downstream of the vacuum/dryer chamber 32, dependent upon specific processing requirements. An in-feed conveyor 35 is positioned upstream of the freeze chamber 31 and conveyors are provided internally of chambers 31 and 32 (and also chamber 33, where present). An out-feed conveyor 37 is provided to collect the sheet 30 exiting the apparatus. Rotary slit valves 38a and 38f are provided on entry and exit from chambers 31, and 33 and may or may not be under vacuum. Consecutive chambers are connected by slit valves 38b, 38c, 38d and 38e which are under vacuum.

A respective base sheet 30 provided with the printed layer structures forming a number of electrode strips 10 in a matrix array is fed from a well 7 filling station (not shown) immediately upstream of the in-feed conveyor 35. As a result, when in position on in-feed conveyor 35 the wells contain the measured dose of the electro-active substance in liquid form, ready to be freeze dried.

Heat transfer into and out of the carrier layer can be modified in a number of ways, for example, holding the base sheet 30 on supports or adding a layer to form a barrier between base sheet 30 and the cooling plate.

Before passing into the freezing chamber and vacuum dryer chamber 32, the base sheet 25, 30 may be insulated in order to alter the processing characteristics in the chambers. Insulation of the base sheet has been shown to enable the processing characteristics to be modified in ways that may be beneficial for freeze drying of certain reagents and substances. Insulation may be achieved by means of use of an insulating backing and or facing for the base sheet 30. Metallic sheets or foam insulation (such as PE foam sheets) has been found to give good results. The provision of insulation for the base sheet (or even the sensor strips/devices per se) has several benefits in terms of processing as will be described. For example:
1. the insulation can be applied to the base sheet or the devices prior to entering the freeze drying system or to the cooling plates themselves; and
2. the insulation separates the sheet containing the target substance from the cooling plates
3. If attached to the base sheet the insulation should be able to be removed following processing.

The insulation is described as such because it tends to insulate the base sheet or devices against susceptibility to be affected by changes in the environmental exposure conditions; especially temperature. The insulation may therefore be heat conductive (such as a metallic heatsink) or non-heat conductive such as PE foam. The insulation can be described alternatively as providing thermal moderation. The shielding, insulation or heatsink may accordingly be characterised as thermal moderator means. The nature and purpose of the thermal moderation is described further later in this document.

In order to feed the base sheet from the in-feed conveyor 35 into the chamber, the rotary slit valve 38a rotates one quarter turn from a closed position to an open position (as shown in FIG. 4) in which the base sheet can be fed through the horizontally aligned slit passage 40 of the valve into the interior of the freeze chamber 31. Passing into the freeze chamber 31 the base sheet 30 is received on a chamber internal conveyor arrangement comprising separate peripheral conveyor bands 43 wrapped around respective pulleys. The respective conveyor bands 43 are provided to underlay respective opposed longitudinally running marginal portions of the base sheet 30. The conveyor feeds the sheet 30 until it is contained wholly within the chamber and the conveyor is deactivated when a reference mark on the base sheet 30 breaks a light beam limit switch.

The freeze chamber 31 contains an upper refrigerated plate 44 and a lower refrigerated plate 47. A refrigeration unit is situated outside the chamber 31 and supplies a heat transfer fluid (typically silicone oil) to cool the plates 44, 47 via conduit connections into the chamber through the outer walls of the chamber. The plates 44, 47 are cooled to a temperature of at least −40° C. In one operational embodiment, the plates 44,47 are cooled to −58° C. The lower plate is normally stationed below the level of the conveyor bands 43 (as shown in bold line in FIG. 4). When the respective base sheet is positioned centrally with respect to the plates 44, 47, the lower plate is raised up (for example by means of pneumatic ram and cylinder arrangement 42) lifting the base sheet 30 from the conveyor and carrying it into close proximity with the upper refrigerated plate 47 (typically to within 3 mm of the upper plate). By positioning the two refrigerated plates 44,47 in close proximity in this way, controlled freezing is achieved. One or both of the refrigerated plates may be provided with ridge, projection or other proud standing formations (for example formations 49) to contact the base sheet at zones not printed with the layer structure electrodes (i.e. at neutral zones) in order to inhibit bowing of the sheet during the freezing stage. Following holding at the raised position sandwiched between the two refrigeration plates for a predetermined period, the base sheet 30 is lowered on plate 44, and replaced on the conveyor bands 43. The rate and timing of raising of the lower plate 44 is controllable and variable to tailor the freezing conditions to meet certain requirements. In particular it may in certain instances be beneficial to modify, alter or tailor the freezing rate of the substance. Typically a balance needs to be struck between rapid freezing (and hence low overall time spent in the freeze chamber 31) and slow freezing to ensure control of crystal size.

Faster freezing enables the overall processing time to be kept at a level for viable production rates. Experimentally it has been found that preferred average freeze rates for realisation of the technique are in the range 5 to 150° C./min. This is achieved by controlling the temperature of the cooling plates and the rise time of the lower plate. Additionally, the insulation of the base sheet as described above has been found to result in more uniform cooling. FIG. 5 shows the effect of raising the bottom cooling plate and insulation of the sheet upon freeze rate. Trace 501 is representative of an experiment in which an insulated sheet is used and the lower cooling plate remains lowered throughout. Trace 502 is representative of a non-insulated base sheet 30 and the lower cooling plate remains lowered throughout. Trace 503 is for an insulated base sheet in which the lower cooling plate is raised immediately following start of the freeze process. Trace 504 is for a non-insulated base sheet in which the lower cooling plate is raised immediately following start of the freeze process. FIG. 6 shows experimental results for the change in freezing rate on the provision of a polyethelene (PE) foam insulating layer, when the cooling plates are set to −58° C.

In order to feed the base sheet 30 out of the freeze chamber 31, the in-chamber conveyor 43 is operated and the base sheet 10 is fed through the horizontally aligned exit pneumatic slit valve 38b into slit passage 40 of the valve to exit the freeze chamber 31.

The temperature of the freeze chamber 31 is maintained substantially at the refrigeration temperature (−40° C. to −60° C.) before, during and after each pass through cycle for each respective base sheet 30. As one base sheet exits the freeze chamber 31, the exit slit valve 38b closes and seals the chamber ready for the next successive base sheet to enter via the entry rotary slit valve 38a. The base sheet is held in the cold environment of the freeze chamber typically for a period in the range 1 to 5 minutes, more typically for approximately 2 minutes, in order to ensure rapid and complete freezing of the liquid present in the well 7. Typically, the gas pressure in the freeze chamber is controlled to be slightly above atmospheric pressure (for example in the region of 5 mBar of nitrogen) and held as such to preventingress of ambient air, particularly when the slit valves 38a,38b are operated. The freeze chamber is purged with dry gas (e.g. nitrogen) in order to preventingress of air and to keep the chamber always dry. The purge is on constantly. This enables the process and apparatus to be used in humid environments.

It is important that the freeze dried deposit is cooled in the freeze chamber to below its collapse temperature. The collapse temperature is defined as the point at which the material softens to the point of not being able to support its own structure.

On exiting the freeze chamber 31 through the exit slit valve 38b, the base sheet passes through a sealed shroud duct 37 and into the vacuum/dryer chamber 32, via the vacuum/dryer inlet pneumatic slit valve 38c, which is at that juncture positioned to receive the base sheet passing through its horizontally orientated slit passage 40. The base sheet 30 is received on a conveyor arrangement 53 positioned internally of the vacuum/dryer chamber 32. The conveyor activates to position the base sheet entirely within the chamber and then is de-activated. The conveyor feeds the sheet 30 until it is contained wholly within the chamber and the conveyor is deactivated when a reference mark on the base sheet 30 breaks a light beam limit switch.

The entry slit valve 38c is then closed in order to seal the vacuum/dryer chamber 32. Total transfer time from being sealed in the vacuum/dryer chamber 32 from being sealed in the freeze chamber 31 is kept to less than 30 seconds more preferably less than 20 seconds or less. The leading edge of the base sheet is therefore exposed to substantially identical conditions as the trailing edge.

Conditions in the drying chamber are such that following sealing and at ambient pressure the ambient temperature is in the region of for example 20° C. to 25° C. A vacuum system, typically including an oil free pump and booster arrangement 57, is operatively associated with the vacuum/dryer chamber 32 enabling the chamber internal pressure to be rapidly and severely dropped. For example in accordance with a first regime of the present invention it may be desirable to drop the vacuum/dryer chamber from ambient pressure immediately following sealing of the chamber to 10⁻² mbar pressure range for about 5 minutes, the reduced vacuum level being reached rapidly, for example within 10 seconds. In an alternative regime in accordance with the invention a pressure drop to a similarly low vacuum pressure may be required, but the pump controlled to achieve this by means of an initial low rate of pressure drop followed by a second period of higher rate pressure drop.

Following operating the reduced pressure regime in the vacuum vacuum/dryer chamber 32 for the required period, the chamber 32 is vented (purged) with an inert gas (preferably nitrogen in a similar manner to the nitrogen purge carried out in freeze chamber 31) until atmospheric pressure is achieved once again within the chamber. At this point the exit slit valve 38d is operated to open the chamber and the conveyer 53 activated to pass the base sheet out of the vacuum dryer chamber. The exit slit valve 38d is similar to, and operates in a similar manner to the slit valves, 38b, 38c, previously described.

As previously mentioned the freeze dried target substance is cooled in the freeze chamber to below its collapse temperature. In the vacuum/dryer chamber the sublimation temperature is also preferably tailored to be below the collapse temperature. It has been found that the temperature at which the sublimation occurs can be tailored by the insulation of the base sheet 30. In the vacuum chamber heating plates are typically positioned above and below the base sheet and are set to a desired temperature (for example 25° C.). The addition of an insulating sheet (for example on the bottom of the base sheet 30) can have a number of effects. The insulation layer slows warming, firstly as the sheet is passed between the freeze chamber 31 and the vacuum/dryer chamber 32, and secondly, when present in the vacuum/dryer chamber 32. It has been found that insulating the base sheet 30 may produce a lowering in the pressure at which sublimation occurs as a result of the decrease in the actual temperature of the base sheet. FIG. 7 shows the experimentally derived temperature profile for insulated and non-insulated sheets transferred from the freeze chamber (set with cold plates set to −58° C.) to the vacuum chamber 32. Only part of the profile showing the difference in temperature of the sheet after transfer from the freeze chamber to vacuum chamber 32 is shown, where trace 701 represents non-insulated sheet, trace 702 represents an insulated sheet and trace 703 represents the application of vacuum.

FIG. 8 shows the pressure traces for measured pressure within the vacuum drying chamber 32 as measured experimentally using a Pirani gauge for a Total Cholesterol (TC) sensor provided with insulation (trace 801), a non-insulated TC (trace 802); a non-insulated blank base sheet (trace 103) and an insulated blank base sheet (trace 804).

Thus the use of appropriate insulation arrangements for the sensors and base sheet can ensure that the freeze drying process and sublimation process parameters (including temperature) can be tailored to produce enhanced effect and result in a dried deposit of superior characteristics.

The heating plates in the chamber 32 may in certain circumstances alternatively be operated to cool the chamber, by being operated at a temperature below chamber or environmental ambient. In this context they may be more accurately described as temperature control means, provided within the vacuum dryer chamber 32.

It has been found that the introduction of a positive flow of inert gas into the vacuum dryer chamber 32 during the application of vacuum lowers the final pressure achieved in the chamber. This inert gas bleed is believed to increase rate of water removal from the deposited, dried substance. Experimentally a nitrogen gas bleed was used. The resulting samples were more cracked than found otherwise and more soluble. FIG. 9 shows the effect of nitrogen bleed on the pressure attained in the vacuum dryer chamber 32. Trace 901 shows the pressure with no nitrogen bleed on. Trace 902 shows the pressure with the nitrogen bleed on. Trace 903 represents the nitrogen delivered (with the bleed off—approximating to zero). Trace 904 shows the nitrogen bleed rate with the bleed on. The preferred bleed rate range is zero-550 ccm. Whilst the purge and bleed scenarios have been described in relation to the use of nitrogen, it should be appreciated that other gases, particularly inert gases, may be suitable.

In certain embodiments the base sheet will exit the vacuum dryer chamber 32 and directly pass for onward processing (such as cutting out of the strips 10) and sealed packaging. In certain embodiments, prior to this a warming stage will be utilised in which the base sheet 30 passes from the vacuum dryer chamber into a warm chamber 33, which is maintained at a temperature above the dew point of the factory. The warm chamber 33 includes a conveyor similar to conveyor 53. An out feed conveyor 47 is provided at the downstream end of the apparatus. The warm chamber may be purged with inert gas (such as nitrogen) in a similar manner, and for similar reasons, as the vacuum dryer chamber. The heating plates in the chamber 33 may in certain circumstances alternatively be operated to cool the chamber, by being operated at a temperature below chamber or environmental ambient. In this context this may be more accurately described as temperature control means, provided within the vacuum dryer chamber 31.

An important advantage of the invention is that efficacious and rapid freeze drying of the liquid target substance is able to be achieved. It is particularly of benefit to have the ability to rapidly reduce the pressure in the vacuum dryer chamber 32 to the desired level and according to the preferred regime, in a chamber separate and distinct from the chamber in which the freeze process step is conducted. This enables the liquids in the target substance to sublime effectively resulting in a high quality dried solid residue remaining. Because the carrier is moved from a freeze chamber to a separate vacuum chamber the environment can be more closely controlled and the cycling of freezing to drying can be more rapid. In this way the base sheet carrier and target substance is subject to the full temperature cycling without the surrounding chamber and apparatus being subject to the full cycle. This reduces time and energy costs.

The technique and apparatus of the present invention enables the freezing and vacuum drying of target substances (held on base sheets or otherwise) to be achieved in a continuous or quasi continuous manner, in which separate freeze and vacuum dryer chambers are utilised. It is also possible to have a warming chamber or multiple freezing chambers. The system of the invention enables additional vacuum dryer, freezing or warming chambers to be added in circumstances where this is beneficial.

In alternative arrangements it is envisaged that a number of base sheets could be fed simultaneously (or sequentially) into, and passed out of, the freeze chamber and or the vacuum dryer chamber. The liquid reagent could be held in containers, wells or vessels other than presented on base sheets. The process and apparatus is envisaged as having applications in other situations in which rapid and accurate freeze drying of liquids (particularly small dosed quantities) is required.

By way of further and better explanation and elucidation of the invention, the following examples are included.

Standard (non-insulated) and insulated sheets were used in the exemplary experimental procedures.

The standard (non-insulated) sheets comprised screen printed electrodes with either punched or laser drilled wells with hydrophobic mesh backing.

The insulated sheets were as for the non-insulated sheets, but with insulating material temporarily attached to the back of the sheet. The insulating material is a Sealed Air Cell-Aire® 1 mm thick polyethylene foam.

Electrodes are standard electrodes as disclosed herein and in, for example, WO200356319.

### Enzyme Mix

Approximate concentrations in final enzyme mix:

### 0.1M Buffer

### 50 mM MgSO₄

5% w/v glycine
1% W/V myo-inositol
1% w/v ectoine
Varying % surfactant
88.8 mM mediators
Enzymes to a total of ˜107.5 mg/ml

### Dispense

1. 0.4 μl of enzyme solution was dispensed using an electronic pipette into all wells of a sensor strip. Each enzyme solution was dispensed into all electrodes on both insulated and non-insulated, electrode sheets comprising punched wells to produce devices suitable to investigate the pressure traces of each enzyme mix.
2. 0.4 μl of enzyme solution was dispensed using an electronic pipette into all four wells of a sensor strip. Each enzyme solution was dispensed into all electrodes on both insulated and non-insulated, electrode sheets comprising laser drilled wells to produce devices suitable for electrochemical testing.

### Freeze Drying

Electrode sheets with nothing dispensed onto them were run through the freeze drying apparatus as controls.

The dispensed sheet was loaded into the freeze drying apparatus and followed the following protocol:

| Variable | Set Point |
|---|---|
| Freeze time | 5 min |
| Freeze Temperature | −58° C. unless |
| | stated otherwise in |
| | the text. |
| Dry Time | 5 min |
| Dry Temperature 1 | 25° C. |
| Warm time | 0.1 min |
| Warm Temperature 1 | 25° C. |

Once the sensors have been freeze dried they are stored in a low relative humidity environment.

### EXAMPLE 1A

A K-type thermocouple was fitted on a PET card and an insulated PET card. These measurements give the temperature profile, of the card and hence the dispensed mixes in the freeze chamber. The experimental conditions are those given in the generic testing section above.

### EXAMPLE 1

An I-button DS 1922L-F50 temperature sensor was fitted on a PET card and an insulated PET card. These measurements give the temperature profile, of the card and hence the dispensed mixes through the freeze dryer system. The sensor saturates at −41° C. but the freezing and warming can be estimated by using the Newton's law of cooling and warming, in these experiments effect of changing the programmed temperature of the cold plates was investigated. The experimental conditions are those given in the generic testing section above.

TABLE 1
showing the effect of cold plate temperature on freezing rate.

| | Freezing rate between |
|---|---|
| Conditions | 20 to −40° C. (° C./min) |
| Plates at −45° C. - not insulated | 60 |
| Plates at −58° C. - not insulated | 100 |
| Plates at −58° C. - insulated | 70 |

### EXAMPLE 2

An I-button DS 1922L-F50 temperature sensor was fitted on a PET card and an insulated PET card. A Sealed Air Cell-Aire® 1 mm thick polyethylene foam was used as the insulating layer. These measurements give the temperature profile, which is undergone by a card and the dispensed mixes through the freeze dryer system. The sensing limit of the I-button sensor is at −41 C but the freezing and warming can be estimated by using the Newton's law of cooling and warming. The experimental conditions are those given in the generic testing section above.

TABLE 2
Effect of using insulating card on the temperature at which the
vacuum is initially applied on transferral between the freezing
and the vacuum chamber.

| Conditions | Temperature (° C.) |
|---|---|
| No insulation | −33 |
| PET insulation | −37 |

### EXAMPLE 3

### Dissolution Testing

Electrochemical performance of the freeze dried deposits was assessed by completing a dissolution test using a PG580 potentiostat to apply a potential of −0.45V for 2 s 60 times with a 0.1 s interval between each application and measures the current. The nitrogen bleed was set to zero. The potential cycle was started and, once a zero point signal had been recorded, 20 μl of delipidated serum applied to the well. The measured current at the end of each 2 s transient was plotted vs. time for each well tested. The current increases with time as the freeze dried deposit dissolves and releases the mediator which is reduced at the electrode surface. The current then plateaus as the dissolution of mediator finishes and the current becomes solely diffusion limited. The time at which the current reaches its diffusion limited value was recorded for each well and the average values are reported in Table 3.

TABLE 3
Effect of using an insulating card on the rate of dissolution of a
freeze drier deposit, as measured by electrochemical response.

| Conditions | Average Dissolution Time (sec) |
|---|---|
| No insulation | 61 |
| with PET insulation | 47 |

### EXAMPLE 4

For the first experiment, the nitrogen bleed was set to zero. No positive pressure of nitrogen was applied. In the second experiment, the nitrogen bleed was opened as soon as the pressure in the drying chamber reached 1 mbar. The nitrogen flow stayed at its maximum (550 sccm) for 56 s and then decreased slowly to reach 0 sccm 130 s after it was turned on.

| | Set Point 1st | Set Point 2nd |
|---|---|---|
| Variable | experiment | experiment |
| Freeze time | 5 min | 5 min |
| Freeze Temperature | −58° C. | −58° C. |
| Dry Time | 5 min | 5 min |
| Dry Temperature 1 | 25° C. | 25° C. |
| RATE | 100 mbar/s | 100 mbar/s |
| Warm time | 0.1 min | 0.1 min |
| Warm Temperature 1 | 25° C. | 25° C. |

### EXAMPLE 5

The experimental conditions are those given in the generic testing section above.

| | | n_{H2O} removed | |
|---|---|---|---|
| | Maximum rate | (10⁻³ mol | n_{H2O} dispensed |
| | (10⁻⁵ mol/s) | calculated) | (10⁻³ mol theory) |
| 72 × 400 nl drops | 1.7 | 1.9 | 1.2 |
| 72 × 800 nl drops | 2.4 | 3.8 | 2.3 |
| 144 × 400 nl drops | 3.8 | 3.8 | 2.3 |

Table 4: Showing the effect of variation in maximum rate of water removal for enzyme solutions depending on whether the same volume of solution is dispensed in single rows of drops containing 400 nl or 800 nl, or two adjacent rows of 400 nl drops.

1-64. (canceled)

65. A process for freeze drying a target substance the process comprising;
providing a target substance carried by a carrier;
passing the carrier and target substance into a freeze chamber to reduce the temperature of the target substance;
passing the carrier and target substance to a separate vacuum chamber, in which a vacuum is applied to promote drying of the target substance;
removing the carrier and target substance from the vacuum chamber.

66. A process according to claim 65, wherein:
i) the target substance comprises an initially liquid substance which results in a solidified target substance following removal of the carrier from the vacuum chamber; and/or
ii) the target substance comprises an electro-active substance; and/or
iii) the carrier and target substance are passed directly from the freeze chamber to the vacuum chamber; and/or
iv) the process is operated as a continuous or quasi continuous process in which a series of respective carriers are passed in sequence through the freeze and vacuum chambers; and/or
v) the freeze chamber is held at a freeze temperature significantly below ambient during and between successive respective passes of carriers and target substances through the chamber.

67. A process according to claim 65, wherein:
i) the freeze chamber and/or the vacuum chamber are sealed during a freeze operation or vacuum application; and/or
ii) the target substance is deposited in a well comprising the carrier; and/or
iii) the carrier comprises an electro-chemical electrode sensor; and/or
iv) the carrier comprises a base sheet or substrate carrying a plurality of electro-chemical electrode sensors; and/or
v) the freeze chamber and vacuum chamber are arranged in side by side relationship for direct transfer of the carrier and target substance from one chamber to the other.

68. A process according to claim 65, wherein:
i) a conveyor is provided for transfer of the carrier between the freeze chamber and the vacuum chamber; and/or
ii) the temperature applied to the carrier and target substance in the freeze chamber is substantially at or below −40 degrees C.; and/or
iii) the temperature applied to the carrier and target substance in the freeze chamber is substantially at or below −60 degrees C.; and/or
iv) the carrier and target substance is held at the freeze temperature in the freeze chamber for 5 minutes or less; and/or
v) the vacuum applied in the vacuum chamber reduces pressure to the region of 10⁻² mbar

69. A process according to claim 65, wherein:
i) the reduced vacuum pressure is applied in the vacuum chamber for 5 minutes or less; and/or
ii) the vacuum is applied according to a regime in which the operating vacuum is reached within 30 seconds or less of sealing of the vacuum chamber; and/or
iii) the vacuum is applied according to a regime in which the operating vacuum is reached within 15 seconds or less of sealing of the vacuum chamber.

70. A process according to claim 65, wherein:
i) the transfer time for the carrier and target substance between the freeze chamber and the vacuum chamber is substantially 5 seconds or less; and/or
ii) the transfer time for the carrier and target substance between the freeze chamber and the vacuum chamber is substantially 3 seconds or less; and/or
iii) the target substance is introduced into a respective micro well of the carrier, the micro well having:
1) a depth substantially in the range 50 μm to 1000 μm; and/or
2) an across side dimension (or diameter) in the range 0.1 mm to 5 mm.

71. A process according to claim 65, wherein:
i) the target substance is provided in micro volume doses in the range 100 nano litres to 1000 nano litres; and/or
ii) the target substance is provided in micro volume does in the range 300 nano litres to 700 nano litres; and/or
iii) the target substance is provided in micro volume does in the range 400 nano litres to 600 nano litres.

72. A process according to claim 65, wherein:
i) the target substance is cooled to below its collapse temperature; and/or
ii) the vacuum chamber sublimation from the target substance occurs at a temperature below its collapse temperature; and/or
iii) the carrier and/or the target material is provided with thermal moderator means arranged to moderate the effect of temperature changes.

73. A process according to claim 72, wherein:
i) the thermal moderator means comprises a thermal insulating arrangement; and/or
ii) the thermal insulating arrangement comprises a backing and/or facing layer for the carrier; and/or
iii) the thermal moderator means comprises a thermally conductive element; and/or
iv) the thermal moderator means is applied prior to entering the freeze chamber; and the moderator means is removed following processing.

74. A process according to claim 65, wherein:
i) during cooling, the temperature drop in the freeze chamber is controlled to be within 5° C./min to 150° C./min; and/or
ii) a vacuum chamber inflow of inert gas is provided during application of the vacuum; and/or
iii) during or between cycles the freeze chamber and/or the vacuum chamber are purged with inert gas.

75. A process according to claim 74, wherein:
i) the purge gas is nitrogen; and/or
ii) both the vacuum and freeze chambers are purged.

76. A method of manufacturing a biosensor device comprising depositing an electro-active reagent substance in solution on a carrier and operating a freeze drying process according to any preceding claim to freeze dry the electro-active reagent substance.

77. Apparatus for freeze drying a liquid target substance, the apparatus comprising:
a freeze chamber in which to reduce the temperature of the target substance; and,
a vacuum chamber adjacent the freeze chamber and to which the target substance is passed following exit from the freeze chamber, and in which a vacuum can be applied to promote drying of the target substance.

78. Apparatus according to claim 77, wherein:
i) a refrigeration system is associated with the freeze chamber, enabling a freeze environment to be created in the freeze chamber; and/or
ii) a refrigeration system associated with the freeze chamber comprises two cooling elements positioned oppositely adjacent one another, preferably wherein the spacing of the cooling elements is adjustable, preferably wherein in adjusting the displacement to bring the two cooling elements into closer proximity, the target substance is caused to be transported by one or other of the elements.

79. Apparatus according to claim 77, wherein the freeze chamber is provided with entry and exit means permitting entry into, and exit out of the freeze chamber, for the target substance.

80. Apparatus according to claim 79, wherein:
i) the entry and exit means are sealable; and/or
ii) valves are provided at the entry and exit means; and/or
iii) respective rotary slit valves are provided at the entry and exit means; and/or
iv) the entry and exit means are co-aligned on a substantially common axis, which is the axis of travel of the target substance across the freeze chamber; and/or
v) transport means is provided internally of the freeze chamber for transportation of the target substance internally of the chamber between entry and exit means, preferably wherein the transport means comprises a conveyor arrangement.

81. Apparatus according to claim 77, in which the vacuum chamber is provided with entry and exit means permitting entry into, and exit out of the vacuum chamber, for the target substance.

82. Apparatus according to claim 81, wherein:
i) the entry and exit means are sealable; and/or
ii) valves are provided at the entry and exit means; and/or
iii) respective rotary slit valves are provided at the entry and exit means; and/or
iv) the entry and exit means are co-aligned on a substantially common axis, which is the axis of travel of the target substance across the freeze chamber; and/or
v) transport means is provided internally of the vacuum chamber for transportation of the target substance internally of the chamber between entry and exit means, preferably wherein the transport means comprises a conveyor arrangement.

83. Apparatus according to claim 77, in which:
i) vacuum generation arrangement is provided for generating the applied vacuum in the vacuum chamber; and/or
ii) the vacuum chamber is provided with inert gas delivery means for venting of the vacuum chamber following application of the vacuum; and/or
iii) a control system is provided for controlling process parameters; and/or
iv) a pressurisation arrangement is provided to enable a positive pressure to be applied in the freeze chamber and or the vacuum chamber.

84. Apparatus according to claim 77, wherein the exit means of the freeze chamber and the entry means of the vacuum chamber are:
co-aligned substantially on the axis of travel of the sample through the apparatus; and/or
arranged in close proximity to one another such that a carrier for a plurality of specimens of target substance can extend, at once, internally of both chambers; and/or connected by a sealed shroud or conduit.
